(19) United States
(12) Patent Application Publication
(10) Pub. No.: US 2008/0113623 A1
(43) Pub. Date: May 15, 2008

(54) Signal quality in a wireless network

(76) Inventor: Eamonn F. Gormley, Bellevue, WA (US)

Correspondence Address: HOLLAND & KNIGHT LLP, 10 ST. JAMES AVENUE, 11th Floor, BOSTON, MA, 02116-3889, US

(21) Appl. No.: 11/595,284

(22) Filed: Nov. 9, 2006

(51) Int. Cl. H04B 17/00

(52) U.S. Cl. 455/67.11

(57) ABSTRACT

Methods and apparatus, including computer program products, for determining signal quality in a wireless network. A computer-implemented method in a wireless network includes determining values for parameters of a wireless signal, comparing those values to predetermined parameter threshold values corresponding to those parameters, assigning parameter quality index values to the parameters based on the parameter threshold values, and assigning a signal quality index value to the wireless signal based on the parameter quality index values.

### FIELD OF INVENTION

The present invention relates to wireless networks and more specifically to signal quality in a wireless network.

### BACKGROUND

Wireless signal quality is an important factor when installing a wireless subscriber station in a wireless network. In line of sight systems, the signal strength, which is measured as a received signal strength indication, is the primary indication of signal quality. Once the received signal strength is measured as being above a predetermined limit, or threshold, the installation of the subscriber station can proceed. However, an installer would prefer to optimize the received signal strength indication to get the best installation possible.

In non line of sight installations, the received signal strength indication may be insufficient as a measure of the signal quality. In non line of sight installations, various factors may affect the signal quality, such as interference from another base station or fast fading, which are not measurable from the received signal strength indication alone. To measure signal quality in non line of sight installations, the installer should measure several different signal parameters and determine if the measured parameters are of a sufficient quality to enable a wireless system antenna installation to proceed at a particular location. However, as the number of parameters an installer has to monitor goes above one, the installation process can become exponentially more difficult.

### SUMMARY

The present invention provides a signal quality index which is a single parameter that includes all the information from several different signal quality parameters

In general, in one aspect, the invention features a computer-implemented method in a wireless network that includes determining values for parameters of a wireless signal, comparing those values to predetermined parameter threshold values corresponding to those parameters, assigning parameter quality index values to the parameters based on the parameter threshold values, and assigning a signal quality index value to the wireless signal based on the parameter quality index values.

In embodiments, the parameters may include a receiver signal strength indication, receive branch imbalance, carrier-to-interference ratio, or received signal mean squared error. In other embodiments, the parameters of the wireless signal are a receiver signal strength indication and a carrier-to-interference ratio.

In certain embodiments, the wireless network includes multiple radio unit receivers and the parameters of the wireless signal include a receiver signal strength indication. In other embodiments, the computer implemented method further includes adjusting the predetermined parameter threshold values corresponding to the receiver signal strength indication based on branch imbalances between the multiple radio unit receivers.

The parameter quality index values are dimensionless numbers from 0 to 100. In certain embodiments, the signal quality index value is equal to a lowest parameter quality index. In various embodiments, a parameter quality index of 50 is a minimum threshold value indicating that the parameter is of a sufficient quality for an installation to proceed. The wireless signal may be a downlink radio frequency signal or an uplink radio frequency signal.

In general, in another aspect, the invention features a wireless network having customer premises equipment, at least one wireless base station, a wireless signal transmitted from the at least one wireless base station to the customer premises equipment, and a signal quality index indicator. The signal quality indicator measures values for parameters of the wireless signal, compares the values to predetermined threshold values corresponding to the parameters, assigns parameter quality index values to the parameters based on the predetermined threshold values corresponding to the parameters, and assigns a signal quality index value to the wireless signal based on the parameter quality index values.

In embodiments, the parameters may include a receiver signal strength indication, receive branch imbalance, carrier-to-interference ratio, and received signal mean squared error. In other embodiments, the parameters of the wireless signal are a receiver signal strength indication and a carrier-to-interference ratio.

In embodiments, the customer premises equipment includes multiple radio unit receivers and the parameters of the wireless signal include a receiver signal strength indication. In other embodiments, the predetermined parameter threshold values corresponding to the receiver signal strength indication are adjusted based on branch imbalances between the multiple radio unit receivers.

The signal quality index indicator may be integral with the customer premises equipment. The parameter quality index is a dimensionless number from 0 to 100. In certain embodiments, the signal quality index value is equal to the lowest parameter quality index. In various embodiments, a parameter quality index of 50 is a minimum threshold value indicating that the parameter is of a sufficient quality for an installation to proceed. The wireless signal may be a downlink radio frequency signal or an uplink radio frequency signal. The customer premises equipment may be a wireless subscriber substation.

In general, in another aspect, the invention features a computer program product, tangibly embodied in an information carrier, for assigning a signal quality index value to a wireless signal. The computer program product is operable to cause data processing apparatus in a wireless network to determine values for parameters of a wireless signal, compare the values to predetermined parameter threshold values corresponding to the parameters, assign parameter quality index values to the parameters based on the parameter threshold values, and assign a signal quality index value to the wireless signal based on the parameter quality index values.

In embodiments, the parameters may include a receiver signal strength indication, receive branch imbalance, carrier-to-interference ratio, and received signal mean squared error. In other embodiments, the parameters of the wireless signal are a receiver signal strength indication and a carrier-to-interference ratio.

In certain embodiments, the wireless network includes multiple radio unit receivers and the parameters of the wireless signal include a receiver signal strength indication. In other embodiments, the predetermined parameter threshold values corresponding to the receiver signal strength indication are adjusted based on branch imbalances between the multiple radio unit receivers.

Each of the parameter quality index values is a dimensionless number from 0 to 100. In certain embodiments, the signal quality index value is equal to the lowest parameter quality index. In various embodiments, a parameter quality index of 50 is a minimum threshold value indicating that the parameter is of a sufficient quality for an installation to proceed. The wireless signal may be a downlink radio frequency signal or an uplink radio frequency signal.

The invention can be implemented to realize one or more of the following advantages. A signal quality index provides an installer a single measure of wireless signal quality that helps increase the speed and efficiency of a wireless antenna or subscriber substation installation. This single measurement enables the installer to compare wireless signal quality at several locations and make an informed decision as to the best location for the wireless antenna or subscriber substation installation.

Further, because the installer only sees a single value between 0 and 100, and is looking to achieve a minimum reading of 50, no additional training of the installation crews is required if any installation criteria is changed. Instead, the changes can be made to the equipment (e.g., through the equipment programming), and the installer only needs to achieve the normal threshold signal quality index of 50 to proceed with the wireless antenna or subscriber substation installation. Similarly, installation crews may install many different types equipment, which may each have different installation criteria. The installation crew need not be trained on each type of equipment's installation thresholds, so long as they achieve the normal threshold signal quality index of 50 to proceed with the installation.

Other features and advantages of the invention are apparent from the following description, and from the claims.

### BRIEF DESCRIPTION OF THE DRAWINGS

FIG. 1 is a block diagram of an exemplary wireless network.

FIG. 2 is an exemplary graph of threshold values compared to parameter quality index.

FIG. 3 is an exemplary table of received signal strength indications thresholds.

FIG. 4 is an exemplary graph of branch imbalance compared to branch imbalance adjustment.

FIG. 5 is an exemplary table of carrier to interface ratio thresholds.

FIG. 6 is an exemplary table of received signal mean squared error thresholds.

Like reference numbers and designations in the various drawings indicate like elements.

### DETAILED DESCRIPTION

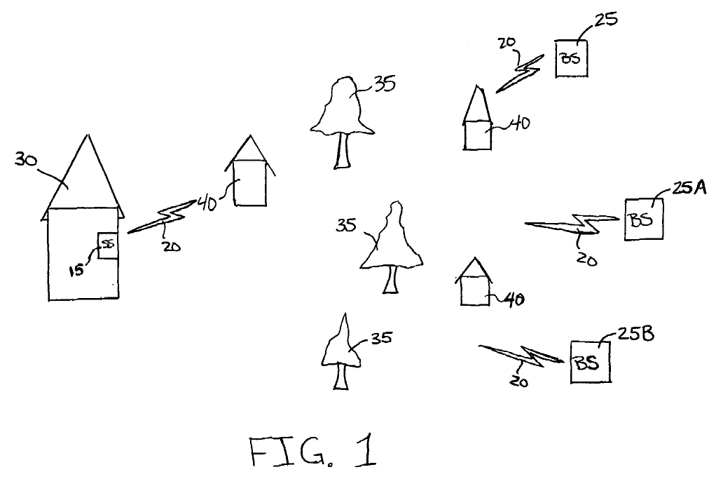

As shown in FIG. 1, an exemplary wireless network 10 includes wireless customer premises equipment, specifically a subscriber station 15 that communicates over one or more air links 20 to one or more base stations 25, 25A, 25B. The subscriber station 15 may be located in a structure 30 and have obstructions, such as trees 35 and other buildings 40, between the structure 30 and the base station 25. This is referred to as a non line of sight installation.

A wireless signal is transmitted over the air link 20 from the base station 25 to the subscriber substation 15. This is referred to as a downlink radio frequency (“RF”) signal or transmission. The downlink RF signal provides information to the subscriber station 15 and should be of such a quality to provide a reliable wireless network to a user. However, because the downlink RF signal must pass through trees 35, buildings 40 and the structure 30, the signal quality may be impaired. To assure the best possible downlink RF signal to the subscriber substation 15, a signal quality index can be generated to assist an installer to position the subscriber substation 15 in a location where the downlink RF signal quality at least satisfies some minimal threshold requirements, and preferably to optimize the location of the subscriber substation 15.

In an embodiment, the signal quality index accounts for several downlink RF signal parameters, including parameters representing a received signal strength indication (“RSSI”), branch imbalances, and carrier-to-interference ratio, the measure of each is described in detail below. In another embodiment, the signal quality index also includes a received signal mean squared error. Each of these downlink RF signal parameters has a passing or acceptable pre-determined threshold. If each of the particular parameters is at or above its passing threshold, the installation of a wireless antenna or subscriber substation may proceed. If the any of the particular parameters is below its passing threshold, the installer should seek a more suitable location in which to install the subscriber substation 15. The signal quality index should indicate when the measured parameters are at or above their respective passing thresholds, and when any one is not.

The signal quality index is a dimensionless value between 0 and 100. That is, the signal quality index is not a percentage and has no units. A signal quality index having a value of 50 and above generally indicates that the downlink RF signal is of such a quality at that particular location that the wireless antenna or subscriber substation installation may proceed at that location. A signal quality index having a value below 50 indicates that the installer should seek another location at which to locate the subscriber substation 15. Since the signal quality index is a measure of the overall signal quality, an installer can quickly move about an installation site to find the best signal quality index available, which will provide a more robust wireless network working from the subscriber substation 15. For example, if the installer finds multiple locations having a signal quality index above 50, he can select the location with the highest signal quality index as the best location for the installation.

The signal quality index is determined by observing a parameter quality index for each downlink RF signal parameter. Like the signal quality index, the value of the parameter quality index is a dimensionless number having values between 0 and 100, and each value represents a threshold for the particular downlink RF signal parameter. The larger a value of the parameter quality index, the better that downlink RF signal parameter. For some parameters, the parameter quality index increases as the parameter value increases. For other parameters, the parameter quality index increases as the parameter value decreases.

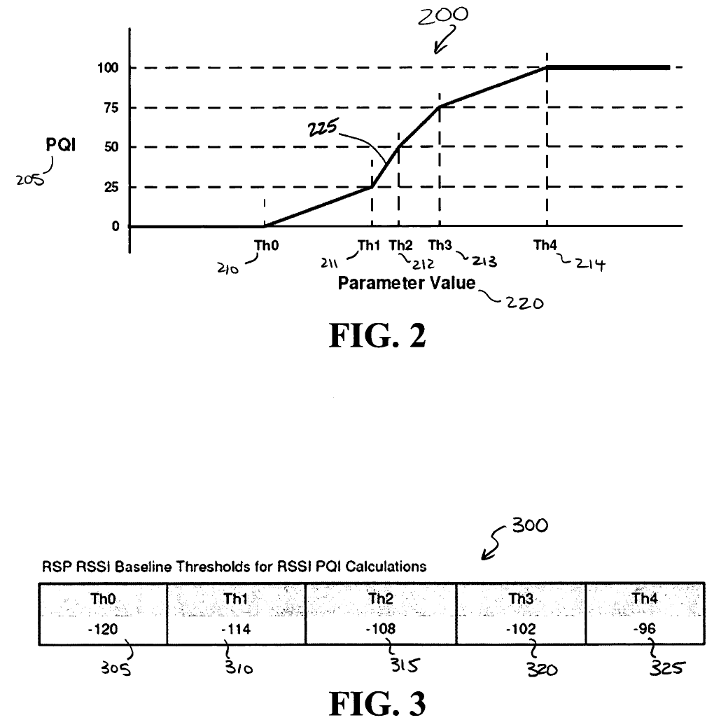

Referring to FIG. 2, a graph 200 depicts an exemplary curve 225 for a parameter quality index 205 at various threshold levels 210, 211, 212, 213, 214. Each of these threshold levels 210, 211, 212, 213, 214 is based on various, pre-defined parameter values 220. A linear curve 225 is drawn between each threshold and parameter quality index intersections to calculate a parameter quality index between each threshold. Each threshold 210, 211, 212, 213, 214 is chosen at points at which the parameter quality index 205 value is 0, 25, 50, 75 and 100. The threshold 212 at which the parameter quality index equals 50 is a minimum value required for that parameter to achieve a satisfactory installation of the subscriber substation 15. This exemplary curve 225 represents the parameter quality index increasing as the parameter value 220 increases. For those parameters that are less acceptable as their value increases, the curve 225 would be reversed vertically (i.e., start at a parameter quality index of 100 at the left of the graph) such that the parameter quality index would decrease (from 100 to 0) as the parameter value increases.

The parameter quality index for each parameter is calculated according to thresholds chosen for that parameter. An exemplary pseudo-code to calculate the parameter quality index is as follows:

if (paramValue < Th0) PQI = 0;
elseif (paramValue < Th1) PQI =
(paramValue − Th0) / (Th1 − Th0) * 25;
elseif (paramValue < Th2) PQI =
(paramValue − Th1) / (Th2 − Th1) * 25 + 25;
elseif (paramValue < Th3) PQI =
(paramValue − Th2) / (Th3 − Th2) * 25 + 50;
elseif (paramValue < Th4) PQI =
(paramValue − Th3) / (Th4 − Th3) * 25 + 75;
else PQI = 100;

In this exemplary pseudo-code, “paramValue” is the “parameter value,” “Th0” is “threshold 0,” “Th1” is “threshold 1,” “Th2” is “threshold 2,” “Th3” is “threshold 3,” “Th4” is “threshold 4,” and “PQI” is the “parameter quality index.” This exemplary pseudo-code represents an example in which the parameter quality index increases as the parameter value increases. For the parameters in which the parameter quality index decreases as the parameter value increases (i.e., higher parameter values=lower parameter quality indexes), this exemplary pseudo-code may be used if an additional step is added at the end. This additional step may be to subtract the parameter quality index calculated from 100 to get an actual parameter quality index for that parameter.

Once all the parameter quality indexes have been calculated for the parameters that make up the signal quality index, they are combined to calculate a signal quality index. In one embodiment, the signal quality index is equal to the minimum parameter quality index calculated. An exemplary pseudo-code to calculate the signal quality index is as follows:

SQI=min(PQIs)

This is the easiest way to insure that all the parameters that affect signal quality are at least above the minimum thresholds. If any one parameter falls below its minimum threshold (e.g., below 50), the signal quality index will be less than the minimum threshold (e.g., 50) and the wireless antenna or subscriber substation installation should not proceed at that particular location. Conversely, if each of the parameters are above the minimum threshold, the signal quality index will also be above the minimum threshold and the installation may proceed at that location.

In an embodiment, the signal quality index includes a RSSI, branch imbalances, and carrier-to-interference ratio. Regarding the RSSI, the base station 25 transmits signals referred to as receiver synchronization pilot signals to the subscriber substation 15. The subscriber substation 15 uses these synchronization pilot signals for synchronization purposes, and the RSSI of the receiver synchronization pilot signals is measured by the subscriber substation 15. The RSSI is measured in units of dBm/synchronization pilot signal at the subscriber substation 15, and is preferably averaged over a period of time (e.g., several seconds).

Referring to FIG. 3, a RSSI baseline table 300 shows various exemplary threshold (Thx) values 305, 310, 315, 320, 325 derived from measured air link signal-to-noise curves for voice channels. In this example, the minimum threshold 315, which would be displayed as a parameter quality index of 50, is shown as −108 dBm/synchronization pilot signal. This is a minimum RSSI required to support 16-quadrature amplitude modulation (QAM) when the subscriber substation 15 receives equal power from each of the base stations 25, in a Rayleigh fading link.

In certain embodiments, the customer premises equipment or subscriber substation 15 may include multiple radio units. For example, the subscriber substation 15 may include two radio unit receivers. In such an embodiment, it is possible that one radio unit receiver will see a stronger signal than the other radio unit receiver, resulting in a receive branch imbalance. When a receive branch imbalance occurs, the receiver signal strength indication that corresponds to the stronger received signal is used as the RSSI for purposes of the receiver signal strength indication parameter quality index calculation. However, a receive branch imbalance adjustment is added to the received signal strength thresholds before the parameter quality index is calculated. This receive branch imbalance adjustment is necessary to accommodate for the fact that the receiver performance is less efficient when the two received signals are of different strengths then when they are both of the higher strength. The receive branch imbalance adjustment is based on the difference in RSSI levels on each of the two radio unit receivers. In one embodiment, the adjustment is based on measurements of the RSSI levels that are required to allow the subscriber substation 15 to continue operating in 16-QAM for various branch imbalances. An exemplary pseudo-code to calculate the adjustment to the receiver signal strength indication thresholds is as follows:

```
MAX_BI_ADJ = 10;
receiveBranchImbalanceAdj = 0;
if (branchImbalance > 3)
{
  receiveBranchImbalanceAdj = (branchImbalance − 3) / 2;
  if receiveBranchImbalanceAdj > MAX_BI_ADJ;
  receiveBranchImbalanceAdj = MAX_BI_ADJ;
}
```

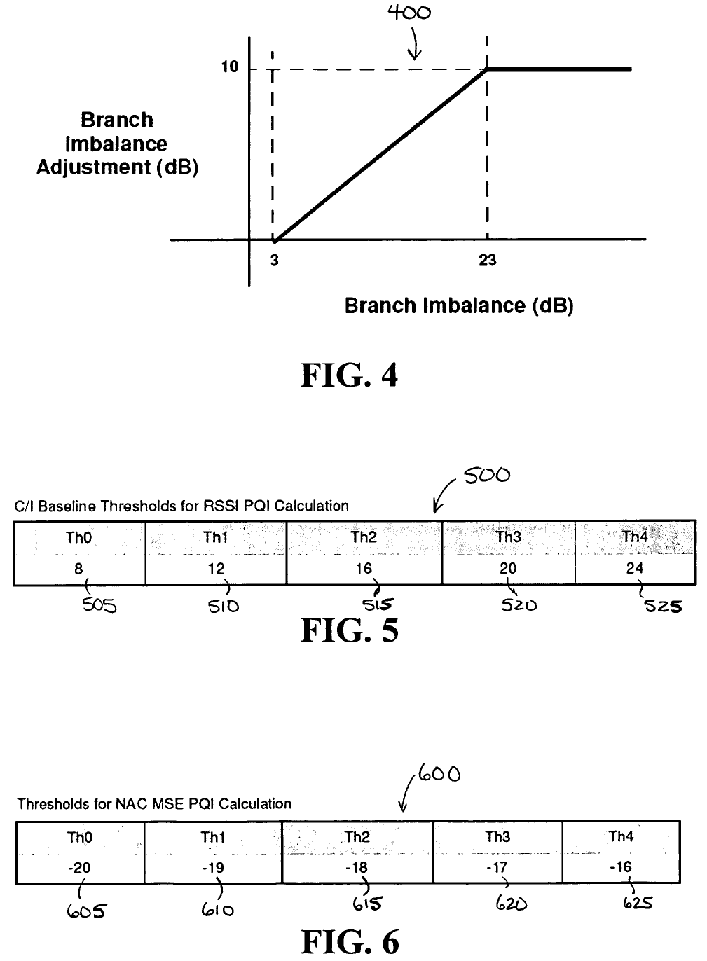

Referring to FIG. 4, an exemplary graph 400 is shown depicting a branch imbalance adjustment compared to a difference in RSSIs on each of the two radio unit receivers. In this example, for a receive branch imbalance between the two radio unit receivers of 3 dB or less, no branch imbalance adjustment is necessary. For a receive branch imbalance between the two radio unit receivers of 23 dB or more, a branch imbalance adjustment of 10 is added to the RSSI thresholds, and the minimum threshold 315 (Th2) would be −98 dBm/synchronization pilot signal (−108+10). Thus, for the wireless antenna or subscriber substation installation to proceed, the stronger signal would have to be a minimum of −98 dBm/synchronization pilot signal.

The carrier-to-interface ratio, which is another parameter that may be included in the signal quality index of this embodiment, is a measure of the interference that the subscriber substation 15 could potentially receive from other base stations 25A, 25B. In an embodiment, the receiver synchronization pilot signals are transmitted from the base stations 25, 25A, 25B with a time-reuse pattern of sixteen different timeslots. The timeslots at which any base station 25, 25A, 25B transmits the receiver synchronization pilot signals is determined by the base station offset code that has been assigned to that particular base station. The subscriber substation 15 receives synchronization pilot signals from its serving bases station 25 during a timeslot that corresponds to the base station offset code of the serving base station 25. The subscriber substation 15 also measures the amount of signal present in the receiver synchronization pilot signals from other base stations 25A, 25B in each of the other 15 timeslots. The level of energy seen in these synchronization pilot signals corresponds to the level of interference the subscriber substation 15 may be subjected to by those base stations 25A, 25B, and is typically measured in dBm. The carrier-to-interference ratio is the strength of the receiver synchronization pilot signal from the serving base station 25 divided by the strength of the receiver synchronization pilot signals from other base stations 25A, 25B.

Referring to FIG. 5, a carrier-to-interference ratio table 500 shows various exemplary threshold values 505, 510, 515, 520, 525 derived by measuring the performance of the system at different carrier-to-interference levels. The minimum threshold 515, which would be displayed as a parameter quality index of 50, is shown as 16 dBm. This is a minimum carrier-to-interference ratio required to support 16-QAM downlink high speed data in an interference limited environment.

In another embodiment, the signal quality index also takes the mean squared error of the network access channel signals into account. The mean squared error of the network access channel signals is determined by measuring the noise on the network access channel signals, which is measured in dBs. This parameter is the inverse of the signal to noise ratio of these signals. The parameter quality index for this parameter increases as the mean squared error of the network access channel signals decreases. Thus, as described above, an exemplary pseudo-code to calculate the parameter quality index for this parameter will have the additional step of subtracting the parameter quality index value generated from 100 to get the actual parameter quality index.

Referring to FIG. 6, a mean squared error of the network access channel signals table 600 shows various exemplary threshold values 605, 610, 615, 620, 625 for the mean squared error. The minimum threshold 615, which would be displayed as a parameter quality index of 50, is shown as −18 dB. Further, since the parameter quality index for this parameter increases as the mean squared error of the network access channel signals decreases, threshold 0 (Th0) 605 would have a parameter quality index of 100 while threshold 4 (Th4) 625 would have a parameter quality index of 0.

The signal quality index may be displayed to the installer in any one of a variety of ways. For example, the signal quality index can be displayed on a handheld installation tool or directly on the equipment to be installed. Further, the display could be a liquid crystal display (LCD) screen or a light emitting diode (LED) display, either of which may display the actual numeric value of the signal quality index or a graphical representation. Further still, an audio signal could be used.

It is to be understood that the foregoing description is intended to illustrate and not to limit the scope of the invention, which is defined by the scope of the appended claims. Other embodiments are within the scope of the following claims. For example, while a subscriber substation has been disclosed, the signal quality index could be used with any customer premises equipment or any wireless network equipment. Further, while certain parameters were described as being included in the signal quality index, other parameter or different parameters could be used to determine the signal quality index as desired by the installer and/or as required by the specific equipment being installed. Also, while certain threshold values were described for various parameters, they were only exemplary. Other threshold values could be used for those same parameters, depending on the particular equipment and installation. Further still, while the signal quality index has been described with reference to downlink signals, a signal quality index may also be used with uplink signals.

What is claimed is:

1. A computer-implemented method comprising:
in a wireless network, determining values for parameters of a wireless signal;
comparing the values to predetermined parameter threshold values corresponding to the parameters;
assigning parameter quality index values to the parameters based on the parameter threshold values; and
assigning a signal quality index value to the wireless signal based on the parameter quality index values.

2. The computer-implemented method of claim 1 wherein the parameters of the wireless signal are selected from the group consisting of receiver signal strength indication, receive branch imbalance, carrier-to-interference ratio, and received signal mean squared error.

3. The computer-implemented method of claim 1 wherein the parameters of the wireless signal are a receiver signal strength indication and a carrier-to-interference ratio.

4. The computer implemented method of claim 1 wherein the wireless network comprises multiple radio unit receivers and the parameters of the wireless signal include a receiver signal strength indication.

5. The computer implemented method of claim 4 further comprising adjusting the predetermined parameter threshold values corresponding to the receiver signal strength indication based on branch imbalances between the multiple radio unit receivers.

6. The computer-implemented method of claim 1 wherein each of the parameter quality index values is a dimensionless number from 0 to 100.

7. The computer-implemented method of claim 6 wherein a parameter quality index of 50 is a minimum threshold value indicating that the parameter is of a sufficient quality for an installation to proceed.

8. The computer-implemented method of claim 1 wherein the signal quality index value is equal to a lowest parameter quality index.

9. The computer-implemented method of claim 1 wherein the wireless signal is selected from the group consisting of a downlink radio frequency signal and an uplink radio frequency signal.

10. The computer-implemented method of claim 1 wherein the signal quality index is displayed on an instrument selected from the group consisting of a handheld instrument and a component of the wireless network.

11. A wireless network comprising:
customer premises equipment;
at least one wireless base station;
a wireless signal transmitted from the at least one wireless base station to the customer premises equipment; and
a signal quality index indicator, the signal quality indicator measuring values for parameters of the wireless signal, comparing the values to predetermined threshold values corresponding to the parameters, assigning parameter quality index values to the parameters based on the predetermined threshold values corresponding to the parameters, and assigning a signal quality index value to the wireless signal based on the parameter quality index values.

12. The wireless network of claim 11 wherein the parameters of the wireless signal are selected from the group consisting of receiver signal strength indication, receive branch imbalance, carrier-to-interference ratio, and received signal mean squared error.

13. The wireless network of claim 11 wherein the parameters of the wireless signal are a receiver signal strength indication and a carrier-to-interference ratio.

14. The wireless network of claim 11 wherein the customer premises equipment comprises multiple radio unit receivers and the parameters of the wireless signal include a receiver signal strength indication.

15. The wireless network of claim 14 further comprising adjusting the predetermined parameter threshold values corresponding to the receiver signal strength indication based on branch imbalances between the multiple radio unit receivers.

16. The wireless network of claim 11 wherein the signal quality index indicator is integral with the customer premises equipment.

17. The wireless network of claim 11 wherein the parameter quality index is a dimensionless number from 0 to 100.

18. The wireless network of claim 17 wherein a parameter quality index of 50 is a minimum threshold value indicating that the parameter is of a sufficient quality for an installation to proceed.

19. The wireless network of claim 11 wherein the signal quality index value is equal to a lowest parameter quality index.

20. The wireless network of claim 11 wherein the wireless signal is selected from the group consisting of a downlink radio frequency signal and an uplink radio frequency signal.

21. The wireless network of claim 11 wherein the customer premises equipment is a wireless subscriber substation.

22. The wireless network of claim 11 wherein the signal quality index is displayed on an instrument selected from the group consisting of a handheld instrument and the customer premises equipment.

23. A computer program product, tangibly embodied in an information carrier, for assigning a signal quality index value to a wireless signal, the computer program product being operable to cause data processing apparatus to:
in a wireless network, determine values for parameters of the wireless signal;
compare the values to predetermined parameter threshold values corresponding to the parameters;
assign parameter quality index values to the parameters based on the parameter threshold values; and
assign a signal quality index value to the wireless signal based on the parameter quality index values.

24. The computer program product of claim 23 wherein the parameters of the wireless signal are selected from the group consisting of receiver signal strength indication, receive branch imbalance, carrier-to-interference ratio, and received signal mean squared error.

25. The computer program product of claim 23 wherein the parameters of the wireless signal are a receiver signal strength indication and a carrier-to-interference ratio.

26. The computer program product of claim 23 wherein the wireless network comprises multiple radio unit receivers and the parameters of the wireless signal include a receiver signal strength indication.

27. The computer program product of claim 26 further comprising adjusting the predetermined parameter threshold values corresponding to the receiver signal strength indication based on branch imbalances between the multiple radio unit receivers.

28. The computer program product of claim 23 wherein each of the parameter quality index values is a dimensionless number from 0 to 100.

29. The computer program product of claim 28 wherein a parameter quality index of 50 is a minimum threshold value indicating that the parameter is of a sufficient quality for an installation to proceed.

30. The computer program product of claim 23 wherein the signal quality index value is equal to a lowest parameter quality index.

31. The computer program product of claim 23 wherein the wireless signal is selected from the group consisting of a downlink radio frequency signal and an uplink radio frequency signal.

32. The computer program product of claim 23 wherein the signal quality index is displayed on an instrument selected from the group comprising a handheld instrument and a component of the wireless network.
